(19) United States
(12) Patent Application Publication
(10) Pub. No.: US 2026/0038946 A1
(43) Pub. Date: Feb. 5, 2026

(54) PACKAGING MATERIAL AND BATTERY PACKAGE

(71) Applicant: FDK CORPORATION, Tokyo (JP)

(72) Inventors: Nobufumi SUZUKI, Tokyo (JP); Chiharu KATO, Tokyo (JP)

(73) Assignee: FDK CORPORATION, Tokyo (JP)

(21) Appl. No.: 19/238,557

(22) Filed: Jun. 16, 2025

(30) Foreign Application Priority Data
Jul. 31, 2024 (JP) 2024-124360

(51) Int. Cl. H01M 50/262; H01M 50/209; H01M 50/227

(52) U.S. Cl. CPC H01M 50/262; H01M 50/209; H01M 50/227

(57) ABSTRACT

A packaging material for arranging and packaging a plurality of tubular batteries each having a tubular shape and having terminals formed on one end surface and the other end surface such that side surfaces of the batteries face each other, the packaging material having a side surface covering portion extending in parallel to an arrangement direction of the plurality of batteries and configured to cover the side surfaces of the plurality of batteries so that a surface of the side surface covering portion is in contact with the side surface. A re-peelable adhesive is applied to at least a part of the surface of the side surface covering portion.

### CROSS-REFERENCE TO RELATED APPLICATIONS

This application claims priority to Japanese Application No. 2024-124360 filed on Jul. 31, 2024, the contents of which are incorporated by reference herein in its entirety.

### TECHNICAL FIELD

An embodiment of the present invention relates to a packaging material and a battery package.

### BACKGROUND ART

A tubular battery having terminals formed on one end surface and the other end surface may be distributed on the market in the form of a battery package in which a plurality of batteries are collectively packaged by a packaging material. For example, Patent Literature 1 discloses a battery package in which a plurality of batteries arranged such that the side surfaces thereof face each other are packaged with a packaging material made of a heat-shrinkable film.

### CITATION LIST

### Patent Literature

Patent Literature 1: JP2009-037917A

### SUMMARY OF INVENTION

The packaging material made of a heat-shrinkable film may be broken when a part of the batteries are taken out, and thus the function of holding other batteries may deteriorate. When the function of the packaging material holding other batteries deteriorates, there is a problem that the other batteries are detached from the packaging, and the plurality of batteries cannot be stored while being packaged with the packaging material.

The disclosed technology has an object to provide a packaging material in which a plurality of batteries are packaged, and when a part of the batteries are taken out, the remaining other batteries are less likely to be detached from the packaging.

An embodiment in the disclosure of the present application is a packaging material for arranging and packaging a plurality of tubular batteries each having a tubular shape and having terminals formed on one end surface and the other end surface such that side surfaces of the batteries face each other, the packaging material having a side surface covering portion extending in parallel to an arrangement direction of the plurality of batteries and configured to cover the side surfaces of the plurality of batteries so that a surface of the side surface covering portion is in contact with the side surface, and a re-peelable adhesive is applied to at least a part of the surface of the side surface covering portion.

According to an aspect of the packaging material disclosed in the present application, it is possible to provide a packaging material in which a plurality of batteries are packaged, and when a part of the batteries are taken out, the remaining other batteries are less likely to be detached from the packaging.

### BRIEF DESCRIPTION OF DRAWINGS

FIG. 1 is a perspective view of a battery package according to an embodiment 1;

FIG. 2 is a front view of the battery package according to the embodiment 1;

FIG. 3 is a right side view of the battery package according to the embodiment 1;

FIG. 4 is a left side view of the battery package according to the embodiment 1;

FIG. 5 is a rear view of the battery package according to the embodiment 1;

FIG. 6 is a top view of the battery package according to the embodiment 1;

FIG. 7 is a bottom view of the battery package according to the embodiment 1;

FIG. 8 is a side view of a battery;

FIG. 9 is an exploded view of a packaging material according to the embodiment 1;

FIG. 10 is an exploded view of a packaging material showing a first modification of a region to which a re-peelable adhesive is applied;

FIG. 11 is an exploded view of a packaging material showing a second modification of a region to which a re-peelable adhesive is applied;

FIG. 12 is a perspective view of a battery package showing a first modification of perforations;

FIG. 13 is a perspective view of a battery package showing a second modification of perforations;

FIG. 14 is a perspective view of a battery package showing a third modification of perforations;

FIG. 15 is a perspective view of a battery package showing a fourth modification of perforations;

FIG. 16 is an exploded view of a packaging material shown in FIG. 15;

FIG. 17 is a perspective view of a battery package showing a fifth modification of perforations;

FIG. 18 is an exploded view of a packaging material shown in FIG. 17; and

FIG. 19 is a view showing another example of the battery package.

### DESCRIPTION OF EMBODIMENTS

Hereinafter, an embodiment of a packaging material and a battery package disclosed in the present application will be described in detail with reference to the drawings. The packaging material and the battery package disclosed in the present application are not limited by the following embodiment.

### Embodiment 1

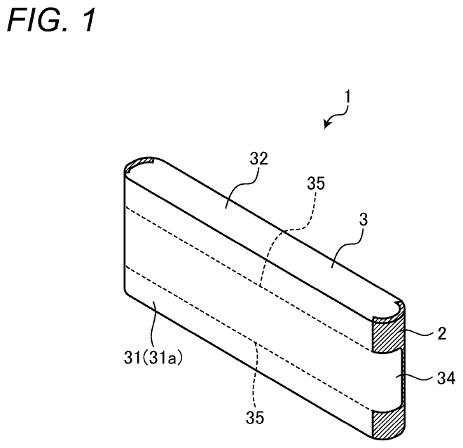

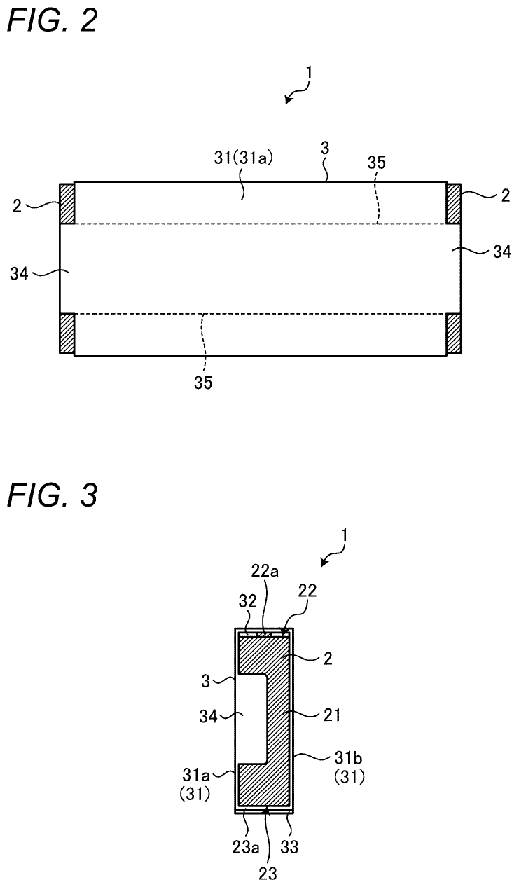

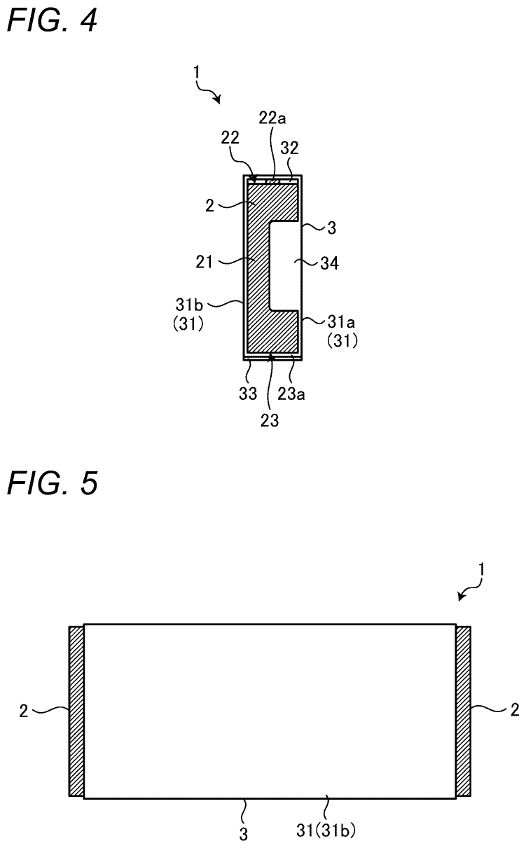

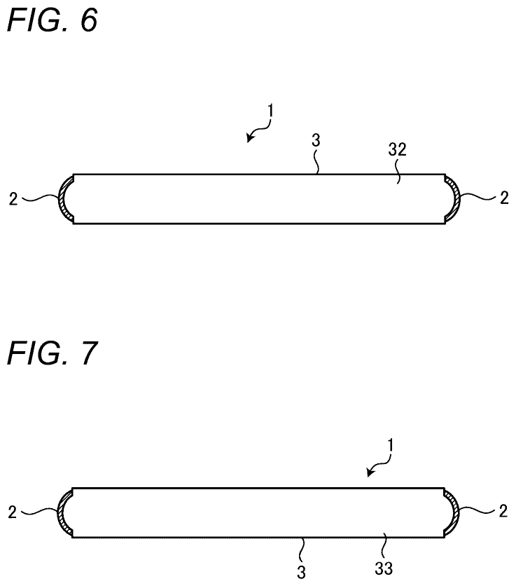

FIG. 1 is a perspective view of a battery package according to an embodiment 1. FIG. 2 is a front view of the battery package according to the embodiment 1. FIG. 3 is a right side view of the battery package according to the embodiment 1. FIG. 4 is a left side view of the battery package according to the embodiment 1. FIG. 5 is a rear view of the battery package according to the embodiment 1. FIG. 6 is a top view of the battery package according to the embodiment 1. FIG. 7 is a bottom view of the battery package according to the embodiment 1. A battery package 1 is formed by packaging a plurality of batteries 2 together with a packaging material 3.

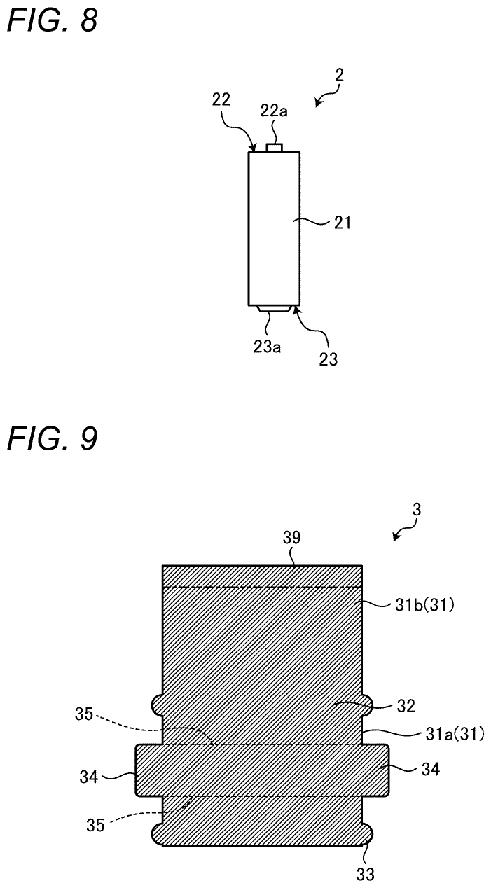

FIG. 8 is a side view of a battery. The battery 2 includes a tubular portion 21 formed in a tubular shape. Both ends of the tubular portion 21 are closed end surfaces, and terminals are formed on both end surfaces. For example, the tubular portion 21 is formed in a cylindrical shape. A positive electrode terminal 22a serving as a terminal is formed on one end surface 22 of the tubular portion 21. A negative electrode terminal 23a serving as a terminal is formed on the other end surface 23 of the tubular portion 21. In the battery package 1, the plurality of batteries 2 are arranged and packaged such that the side surfaces thereof face each other. In the drawings of the battery package 1 shown in FIGS. 1 to 7, the plurality of batteries 2 are packaged with the one end surface 22 on which the positive electrode terminal 22a is formed facing the top surface side. In the following description, a direction in which the plurality of batteries 2 are arranged is simply referred to as an arrangement direction. A direction (a direction from the positive electrode terminal 22a toward the negative electrode terminal 23a) along the central axis of the tubular portion 21 of the battery 2 is simply referred to as an axial direction.

FIG. 9 is an exploded view of a packaging material according to the embodiment 1. The packaging material 3 is a sheet-shaped member. Examples of the material for the packaging material 3 include a resin film and paper. The packaging material 3 includes a side surface covering portion 31, a one end surface covering portion 32, the other end surface covering portion 33, and an extending portion 34.

As shown in FIGS. 1 to 7, the side surface covering portion 31 extends parallel to the arrangement direction of the plurality of batteries 2 and covers the side surfaces of the plurality of batteries 2 in a state of covering the plurality of batteries 2. The side surface covering portion 31 includes a first side surface covering portion 31a and a second side surface covering portion 31b provided on the opposite side of the first side surface covering portion 31a across the plurality of batteries 2.

The one end surface covering portion 32 covers the one end surfaces 22 of the plurality of batteries 2. The one end surface covering portion 32 covers the positive electrode terminal 22a (see also FIG. 8) formed on the one end surface 22. The other end surface covering portion 33 covers the other end surface 23. The other end surface covering portion 33 covers the negative electrode terminal 23a (see also FIG. 8) formed on the other end surface 23.

The side surface covering portion 31, the one end surface covering portion 32, and the other end surface covering portion 33 form the tubular packaging material 3 that accommodates the plurality of batteries 2 therein. In order to form the tubular packaging material 3 by the side surface covering portion 31, the one end surface covering portion 32, and the other end surface covering portion 33, the second side surface covering portion 31b is provided with an overlapping margin 39 for overlapping and joining with the other end surface covering portion 33.

The extending portion 34 extends along the arrangement direction from the end portion of the first side surface covering portion 31a along the arrangement direction. The extending portion 34 covers a part of a region that is the side surface of the battery 2 provided at the end among the plurality of batteries 2 and that is exposed from the side surface covering portion 31. The extending portion 34 is shorter than the length of the tubular portion 21 of the battery 2 in the axial direction.

As shown in FIG. 2 and the like, an example has been shown in which the extending portions 34 are formed on both sides of the first side surface covering portion 31a. Alternatively, one extending portion 34 may be formed on the second side surface covering portion 31b.

Two perforations 35 extending along the arrangement direction are formed in the first side surface covering portion 31a. Each of the two perforations 35 extends to the end portion of the first side surface covering portion 31a. By pulling the region sandwiched between the two perforations 35, the first side surface covering portion 31a is cut along the perforations 35. The two perforations 35 are formed at positions to be cut when the extending portion 34 is pulled. For example, in the example shown in FIG. 2 and the like, the perforation 35 extends from a corner portion where the extending portion 34 and the first side surface covering portion 31a are connected. If the perforation 35 extends from a portion where the extending portion 34 is not formed, the first side surface covering portion 31a can be cut along the perforation 35 by pulling the extending portion 34. When one extending portion 34 is formed in the second side surface covering portion 31b, two perforations 35 are also formed in the second side surface covering portion 31b similarly to the first side surface covering portion 31a.

A re-peelable adhesive is applied to at least a part of a surface of the packaging material 3 facing the plurality of batteries 2 in a state in which the plurality of batteries 2 are packaged. Specifically, in each of the first side surface covering portion 31a, the second side surface covering portion 31b, the one end surface covering portion 32, the other end surface covering portion 33, and the extending portion 34, the re-peelable adhesive is applied to at least a part of the surface facing the plurality of batteries 2. Accordingly, the packaging material 3 is attached to the battery 2. The re-peelable adhesive is applied, so that the packaging material 3 can be attached to the battery 2 again after being peeled off from the battery 2.

In FIG. 9, the region is hatched where the re-peelable adhesive is applied. In the example shown in FIG. 9, the re-peelable adhesive is applied to the entire packaging material 3.

In the battery package 1 in which the plurality of batteries 2 are packaged with the packaging material 3, the packaging material 3 to which the re-peelable adhesive is applied is attached to the batteries 2, thereby preventing the batteries 2 from falling off from the battery package 1.

Since the extending portion 34 is attached to the side surface of the battery 2 provided at the end among the plurality of batteries 2, the battery 2 is more reliably prevented from falling off from the end. Since the region other than the extending portion 34 is also attached to the battery 2 with the re-peelable adhesive, even when the extending portion 34 is not provided, the effect of preventing the battery 2 from falling off from the battery package 1 can be attained.

When the plurality of batteries 2 are packaged with a resin film, the resin film may be brought into close contact with the plurality of batteries 2 by so-called shrink packaging in which the resin film is thermally shrunk to prevent the batteries 2 from falling off. On the other hand, when the packaging material 3 is made of paper, the packaging material 3 cannot be thermally shrunk, but the packaging material 3 can be attached to the battery 2 to prevent the battery 2 from falling off by applying the re-peelable adhesive.

In the battery package 1, a part of the batteries 2 may be taken out alone and used. In this case, the extending portion 34 is pulled and peeled off from the battery 2, the first side surface covering portion 31a is cut until the battery 2 to be used is exposed, and the exposed battery 2 is taken out. Since the extending portion 34 is coated with the re-peelable adhesive, the extending portion 34 can be attached to the side surface of the battery 2 again. Therefore, by attaching the extending portion 34 to the side surface of the battery 2 newly provided at the end among the plurality of batteries 2 remaining in the battery package 1, it is possible to prevent the battery 2 at the end from falling off during storage of the battery package 1.

In a case in which the plurality of batteries 2 are packaged with a resin film, when a part of the batteries 2 are taken out, the film may break, the function of holding the remaining batteries 2 may deteriorate, and the remaining batteries 2 may fall off. On the other hand, in the battery package 1 using the packaging material 3 according to the embodiment 1, by attaching the extending portion 34, even when the film is broken, the remaining batteries 2 are less likely to fall off.

Since the positive electrode terminal 22a is covered by the one end surface covering portion 32, the positive electrode terminal 22a is prevented from rusting. Since the negative electrode terminal 23a is covered by the other end surface covering portion 33, the negative electrode terminal 23a is prevented from rusting.

Next, a modification of a region to which a re-peelable adhesive is applied will be described. FIG. 10 is an exploded view of a packaging material showing a first modification of the region to which a re-peelable adhesive is applied. As shown in FIG. 10, the re-peelable adhesive may be applied to a region avoiding the one end surface covering portion 32. In this case, the one end surface covering portion 32 is not stuck to the positive electrode terminal 22a of the battery 2. Therefore, for example, when a perforation is formed along the boundary between the one end surface covering portion 32 and the side surface covering portion 31, it is easy to separate the one end surface covering portion 32 by cutting along the perforation.

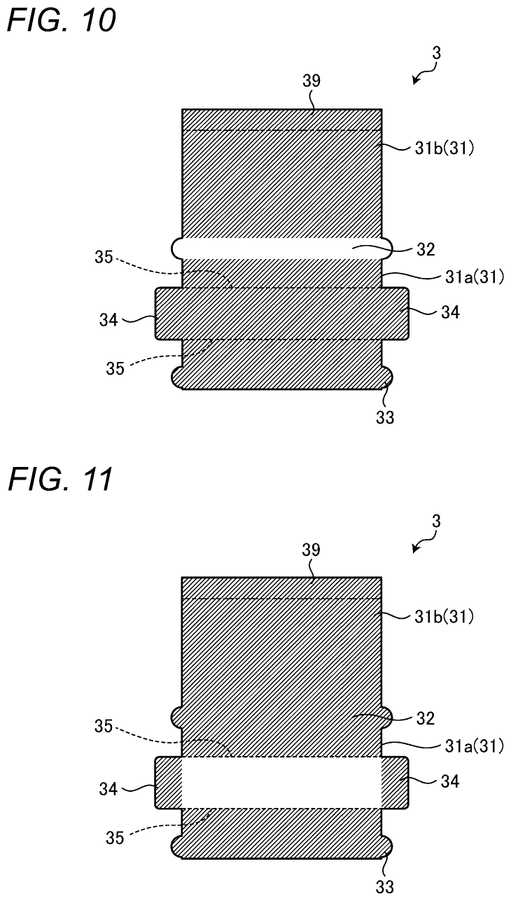

FIG. 11 is an exploded view of a packaging material showing a second modification of a region to which a re-peelable adhesive is applied. As shown in FIG. 11, the re-peelable adhesive may be applied to the first side surface covering portion 31a so as to avoid a region between the two perforations 35. In this case, the region between the two perforations 35 is not attached to the battery 2. Therefore, when the extending portion 34 is pulled to cut the first side surface covering portion 31a along the perforations 35, the region between the two perforations 35 can be easily separated from the battery 2. Accordingly, a small force is required to pull the extending portion 34 in order to separate the region between the two perforations 35 from the battery while cutting along the two perforations 35. Therefore, the battery 2 can be easily taken out from the battery package 1.

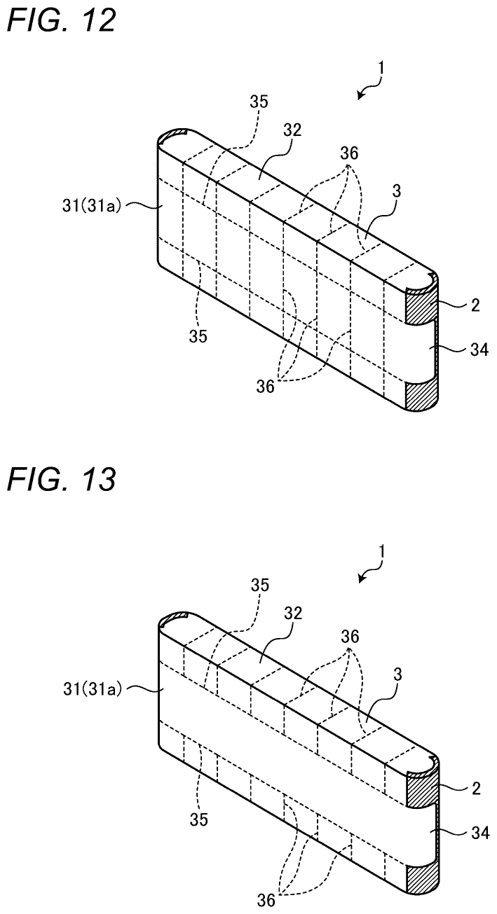

Next, a modification of the perforation formed in the packaging material 3 will be described. FIG. 12 is a perspective view of a battery package showing a first modification of perforations. In the first modification of the perforation, in addition to the perforation 35, a plurality of perforations 36 extending in a direction perpendicular to the arrangement direction are formed in the side surface covering portion 31, the one end surface covering portion 32, and the other end surface covering portion 33. The plurality of perforations 36 extending in the direction perpendicular to the arrangement direction are formed at, for example, the positions between the adjacent batteries 2 in the front view (the state shown in FIG. 2). Accordingly, when the battery 2 is taken out from the battery package 1, a part of the packaging material 3 that is not attached to the battery 2 can be easily cut off along the perforations 36.

FIG. 13 is a perspective view of a battery package showing a second modification of perforations. In the second modification of the perforation, the plurality of perforations 36 extending in a direction perpendicular to the arrangement direction are formed as in the first modification. In the second modification, the plurality of perforations 36 extending in the direction perpendicular to the arrangement direction are formed to avoid a region between the two perforations 35 extending along the arrangement direction. Accordingly, when the perforation 36 is formed between the two perforations 35, the extending portion 34 may be cut at the perforation 36 when the extending portion 34 is pulled, the extending portion 34 may be separated, and the battery 2 may not be prevented from falling off by attaching the extending portion 34 again. In the second modification, since the perforation 36 is not formed between the two perforations 35, unintended separation of the extending portion 34 due to being cut at the perforation 36 is prevented.

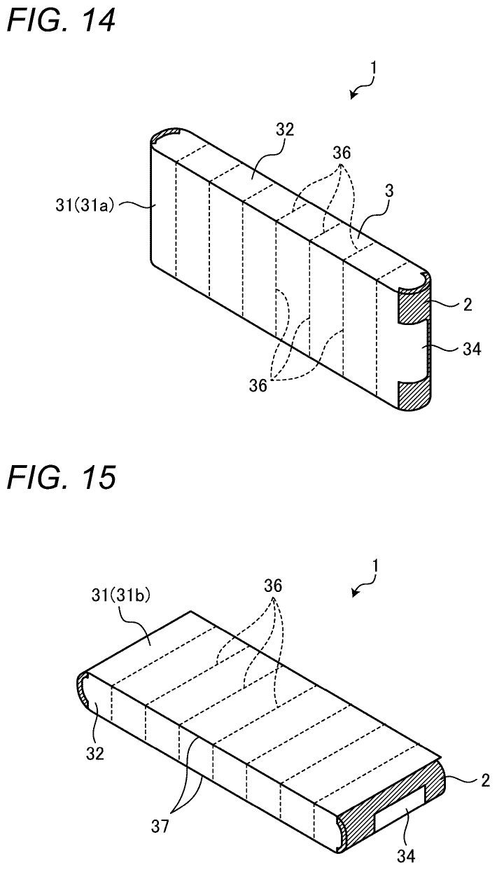

FIG. 14 is a perspective view of a battery package showing a third modification of perforations. In the third modification of the perforation, the perforation 35 extending along the arrangement direction is not formed, and the perforation 36 extending perpendicularly to the arrangement direction is formed. In this case, when the battery 2 is taken out from the battery package 1, a part of the packaging material 3 that is not attached to the battery 2 can also be easily cut off along the perforations 36. When the packaging material is cut off, the extending portion 34 is also cut off, but vibration or impact that causes the battery 2 to which the side surface covering portion 31 is stuck to fall off from the battery package 1 is often applied mainly in the process of circulation of the battery package 1. Therefore, at the stage in which the battery package 1 is stored by the user, the battery 2 is less likely to fall off even when the extending portion 34 is not attached.

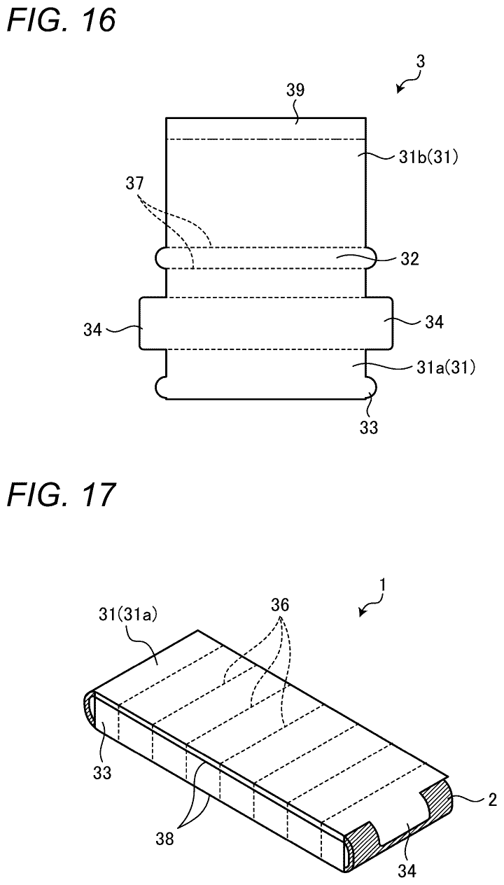

FIG. 15 is a perspective view of a battery package showing a fourth modification of perforations. FIG. 16 is an exploded view of a packaging material shown in FIG. 15. In the fourth modification of the perforation, in addition to the perforation 36, a perforation 37 extending along the boundary between the one end surface covering portion 32 and the side surface covering portion 31 is formed. The perforation 37 is formed, so that the one end surface covering portion 32 can be easily separated. The number of perforations to be formed is increased, so that the number of variations of the procedure for separating the packaging material 3 when a part of the batteries 2 are taken out from the battery package 1 is increased, and the user can select a separating method according to the preference.

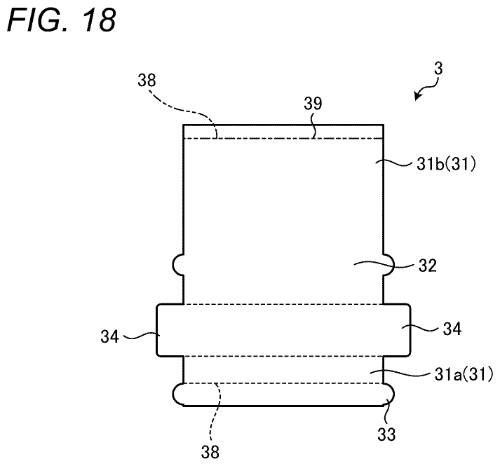

FIG. 17 is a perspective view of a battery package showing a fifth modification of perforations. FIG. 18 is an exploded view of a packaging material shown in FIG. 17. In the fifth modification of the perforation, in addition to the perforation 36, a perforation 38 extending along the boundary between the other end surface covering portion 33 and the side surface covering portion 31 is formed. The perforation 38 is formed, so that the other end surface covering portion 33 can be easily separated. The number of perforations to be formed is increased, so that the number of variations of the procedure for separating the packaging material 3 when a part of the batteries 2 are taken out from the battery package 1 is increased, and the user can select a separating method according to the preference. The perforation 38 is also formed at the boundary between the overlapping margin 39 and the second side surface covering portion 31b.

The combination of the perforations 35, 36, 37, and 38 formed in the packaging material 3 is not limited to the example described above, and may be formed in a different combination. For example, both the perforation 37 and the perforation 38 may be formed in the packaging material 3.

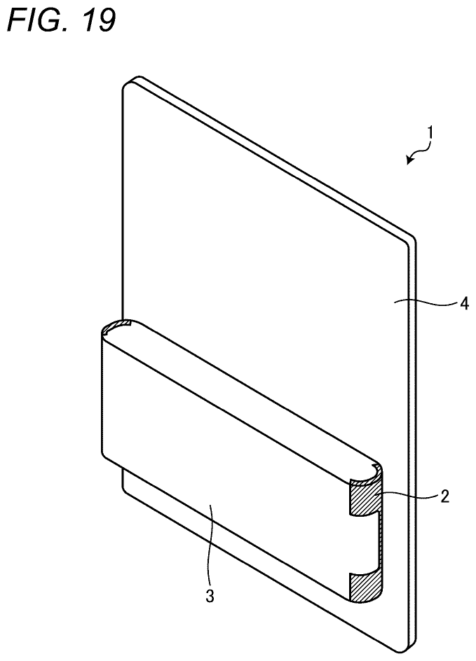

FIG. 19 is a view showing another example of the battery package. As shown in FIG. 19, the packaging material 3 may be attached to a mount 4 to form the battery package 1. The battery package 1 including the mount 4 can be blister packaged.

What is claimed is:

1. A packaging material for arranging and packaging a plurality of tubular batteries each having a tubular shape and having terminals formed on one end surface and the other end surface such that side surfaces of the batteries face each other, the packaging material comprising
a side surface covering portion extending in parallel to an arrangement direction of the plurality of batteries and configured to cover the side surfaces of the plurality of batteries so that a surface of the side surface covering portion is in contact with the side surface,
wherein a re-peelable adhesive is applied to at least a part of the surface of the side surface covering portion.

2. The packaging material according to claim 1, further comprising
a one end surface covering portion formed integrally with the side surface covering portion and configured to cover the one end surface of each of the plurality of batteries.

3. The packaging material according to claim 2, further comprising
the other end surface covering portion formed integrally with the side surface covering portion and configured to cover the other end surface of each of the plurality of batteries.

4. The packaging material according to claim 3,
wherein the side surface covering portion includes a first side surface covering portion and a second side surface covering portion provided on an opposite side of the first side surface covering portion across the plurality of batteries.

5. The packaging material according to claim 4,
wherein a re-peelable adhesive is not applied to at least one of the one end surface covering portion and the other end surface covering portion.

6. The packaging material according to claim 4,
wherein the side surface covering portion, the one end surface covering portion, and the other end surface covering portion have perforations extending in a direction perpendicular to the arrangement direction.

7. The packaging material according to claim 4, further comprising
an extending portion extending from an end portion of the first side surface covering portion along the arrangement direction of the batteries and configured to cover a part of the side surface exposed from the side surface covering portion,
wherein a re-peelable adhesive is applied to at least a part of a surface of the extending portion in contact with the side surface.

8. The packaging material according to claim 6, comprising
a perforation extending along a boundary between the side surface covering portion and the one end surface covering portion.

9. The packaging material according to claim 6, comprising
a perforation extending along a boundary between the side surface covering portion and the other end surface covering portion.

10. The packaging material according to claim 7,
wherein the first side surface covering portion has two perforations extending along the arrangement direction.

11. The packaging material according to claim 10,
wherein a re-peelable adhesive is applied to the first side surface covering portion so as to avoid a region between the two perforations.

12. The packaging material according to claim 10,
wherein the side surface covering portion, the one end surface covering portion, and the other end surface covering portion have perforations extending in a direction perpendicular to the arrangement direction.

13. The packaging material according to claim 12,
wherein the perforations extending in the direction perpendicular to the arrangement direction are formed to avoid the region between the two perforations extending along the arrangement direction.

14. The packaging material according to claim 1,
wherein the packaging material is made of paper.

15. A battery package comprising:
the packaging material according to claim 1; and
a plurality of batteries packaged in the packaging material.

16. A battery package comprising:
the packaging material according to claim 2; and
a plurality of batteries packaged in the packaging material.

17. A battery package comprising:
the packaging material according to claim 3; and
a plurality of batteries packaged in the packaging material.

18. A battery package comprising:
the packaging material according to claim 4; and
a plurality of batteries packaged in the packaging material.

19. A battery package comprising:
the packaging material according to claim 14; and
a plurality of batteries packaged in the packaging material.

20. The battery package according to claim 15, further comprising
a mount to which the packaging material is attached.
